(19) United States
(12) Patent Application Publication
(10) Pub. No.: US 2014/0146362 A1
(43) Pub. Date: May 29, 2014

(54) IMAGE PROCESSING APPARATUS, CONTROL METHOD FOR IMAGE PROCESSING APPARATUS, AND STORAGE MEDIUM

(71) Applicant: CANON KABUSHIKI KAISHA, Tokyo (JP)

(72) Inventor: Kimimori Eguchi, Yokohama-shi (JP)

(73) Assignee: CANON KABUSHIKI KAISHA, Tokyo (JP)

(21) Appl. No.: 14/088,119

(22) Filed: Nov. 22, 2013

(30) Foreign Application Priority Data
Nov. 26, 2012 (JP) 2012-257557

(51) Int. Cl. H04N 1/00

(52) U.S. Cl. CPC H04N 1/00474; H04N 1/00803
USPC 358/1.15

(57) ABSTRACT

An image processing apparatus includes a reception unit configured to receive a setting when an input image is output, a determination unit configured, by acquiring a number of sheets of the input image and a content of the setting received by the reception unit and acquiring a number of output sheets reduced by executing blank-sheet skip processing on the image, to determine whether an effect is achieved when the blank-sheet skip is executed, and a display unit configured to perform a display for prompting an execution of the blank-sheet skip processing determined as having the effect by the determination unit.

### BACKGROUND OF THE INVENTION

1. Field of the Invention

The present invention relates to processing for recommending processing that can be provided to users who use image processing apparatuses.

2. Description of the Related Art

In recent years, in addition to enhancement of functions/services offered on electrophotographic apparatuses or printers, etc., functions/services offered to users, such as increase in functions/services performed on a cloud via devices are increasing exponentially. However, many users may use only a fraction of the offered functions or services. Various reasons can be thought of, but it could be considered that the users are not aware of newly added functions.

Further, as another reason, it could be considered that although the users can partly find out an effect of its function by the name of a button, they cannot find out, in detail, a condition and an intended use to which the function is applied, and an effect that is achieved when the function is actually applied.

To deal with the above-described problem, in conventional image processing apparatuses, even if an instruction of blank-sheet skip is not received from a user, when a document is copied, it is always determined whether the read out document is a blank-sheet. Then, when it is determined that the document is a blank-sheet, a display is performed accordingly, and the user is made to select whether the blank-sheet is not to be copied (whether to perform blank-sheet skip). Consequently, even if the user does not instruct blank-sheet skip execution at the start of copying, there is a method for executing the blank-sheet skip on image data which is a processing target (Japanese Patent Application Laid-Open No. 2008-22276).

However, when images to be read out are always determined and subjected to execution of the blank-sheet skip as described above, deviation may occur between a result that is achieved by executing the blank-sheet skip, and an effect which the user seeks with respect to an output product (output result).

For example, in a case where the user instructs to start copying on the images targeted for processing based on 2-in-1 or two-sided setting, a number of sheets of an output product is not reduced, even when blank-sheet skip, which is not instructed by the user with respect to the document, is executed. In other words, an effect of the blank-sheet skip with respect to the output product may not be achieved. For this reason, despite the fact that a number of sheets is not decreased and that an effect of the blank-sheet skip processing is not achieved, page composition will be changed.

### SUMMARY OF THE INVENTION

The present invention is directed to an image processing apparatus.

According to an aspect of the present invention, an image processing apparatus includes a reception unit configured to receive a setting when an input image is output, a determination unit configured, by acquiring a number of sheets of the input image and a content of the setting received by the reception unit and acquiring a number of output sheets reduced by executing blank-sheet skip processing on the image, to determine whether an effect is achieved when the blank-sheet skip is executed, and a display unit configured to perform a display for prompting an execution of the blank-sheet skip processing determined as having the effect by the determination unit.

Further features of the present invention will become apparent from the following detailed description of exemplary embodiments with reference to the attached drawings.

According to an aspect of the present invention, using a content of the setting when input images are output, and an analysis result of processing target images, it is determined whether an effect is achieved when blank-sheet skip processing is executed on the input images. If it is determined that the effect is achieved by executing the blank-sheet skip processing, it becomes possible to suggest an execution of the image processing to a user.

As a result, only when an effect is achieved, an execution of the blank-sheet skip processing can be suggested to the user. Therefore, even if the user does not find out, in detail, a condition and an intended use to which the function is applied, and an effect achieved when the function is actually applied, useful image processing can be executed on the processing target images.

### BRIEF DESCRIPTION OF THE DRAWINGS

FIG. 1 is an overall diagram of a system.

FIG. 2 is a block diagram illustrating a hardware configuration of an image processing apparatus.

FIG. 3 is a block diagram illustrating a hardware configuration of a cloud service server.

FIG. 4 is a diagram illustrating a software configuration of the image processing apparatus.

FIG. 5 is a diagram illustrating a software configuration of the cloud service server.

FIG. 6, composed of FIGS. 6A and 6B, is a sequence diagram illustrating operations for executing a series of processes of a first exemplary embodiment.

FIG. 7 is a sequence diagram illustrating operations for executing a series of processes of a second exemplary embodiment.

FIG. 8, composed of FIGS. 8A and 8B, is a flowchart illustrating a third exemplary embodiment.

FIG. 9A is a block diagram illustrating a configuration in an image processing unit. FIG. 9B is block diagram illustrating a configuration in a recommended processing unit. FIG. 9C is a block diagram illustrating a configuration in an image determination unit. FIG. 9D is a block diagram illustrating a configuration in an effect determination unit.

FIG. 10 is a flowchart of the effect determination unit configured to determine whether blank-sheet skip has an effect.

FIG. 11 is a flowchart of the effect determination unit configured to determine whether character highlight has an effect.

FIG. 12 is a flowchart for performing effect determination from setting values, when determining whether character highlight has an effect.

FIG. 13, composed of FIGS. 13A and 13B, is a flowchart illustrating a fourth exemplary embodiment.

FIG. 14 is a message indicating an effect of blank-sheet skip and a user interface (UI) for allowing a user to select whether to execute blank-sheet skip in the first exemplary embodiment.

FIG. 15 is a UI indicating an effect of the blank-sheet skip in the first exemplary embodiment.

FIG. 16 is a message indicating an effect of character highlight and a UI for allowing a user to select whether to execute character highlight in the third exemplary embodiment.

FIG. 17 is a UI indicating an effect of character highlight in the third exemplary embodiment.

### DESCRIPTION OF THE EMBODIMENTS

Various exemplary embodiments for implementing the present invention will be described with reference to the drawings. The following exemplary embodiments are not intended to limit the claimed invention, and all combinations of features described in the exemplary embodiments are not necessarily essential for a solving means of the invention.

In a first exemplary embodiment, an image processing apparatus 101 determines, from an analysis result of an input processing target image, and a setting value when the processing target image is input or output, whether an effect is achieved with respect to an output result of the processing target image, when blank-sheet skip processing is executed on the processing target image. Then, only when it is determined that the effect is achieved, descriptions about a case where an execution of the blank-sheet skip processing is recommended to the user will be provided.

### <Overall Configuration of System>

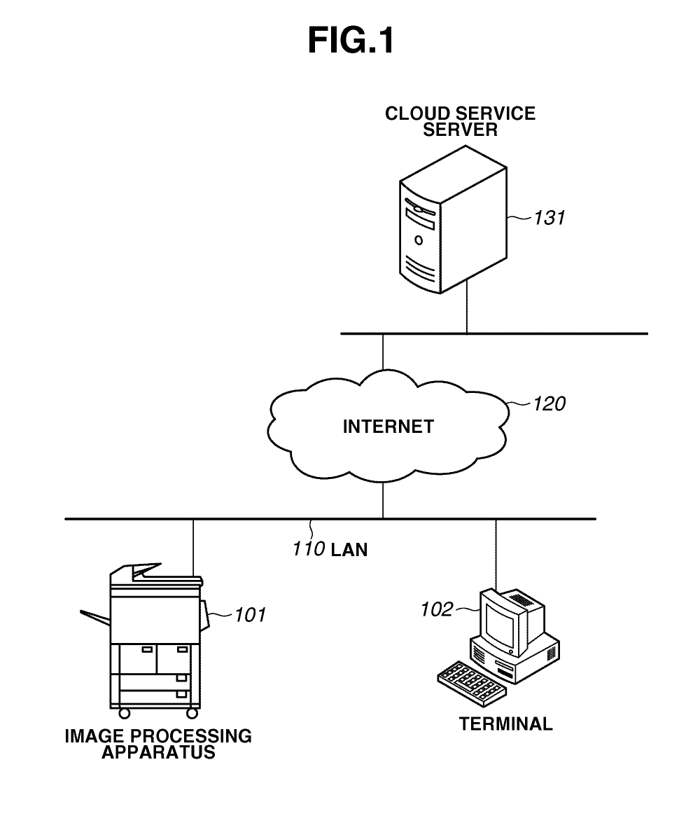

FIG. 1 is an overall diagram of a system in the present exemplary embodiment. To a local area network (LAN) 110, an image processing apparatus 101 and a terminal 102 are connected. Further, the LAN 110 is connected to an Internet 120, and also to a cloud service server 131 that offers services via the Internet 120. The terminal 102 is connected to the LAN 110, but it is not limited to this. The terminal 102 only needs to be connectable to the cloud service server 131.

### <Hardware Configuration Example—Image Processing Apparatus>

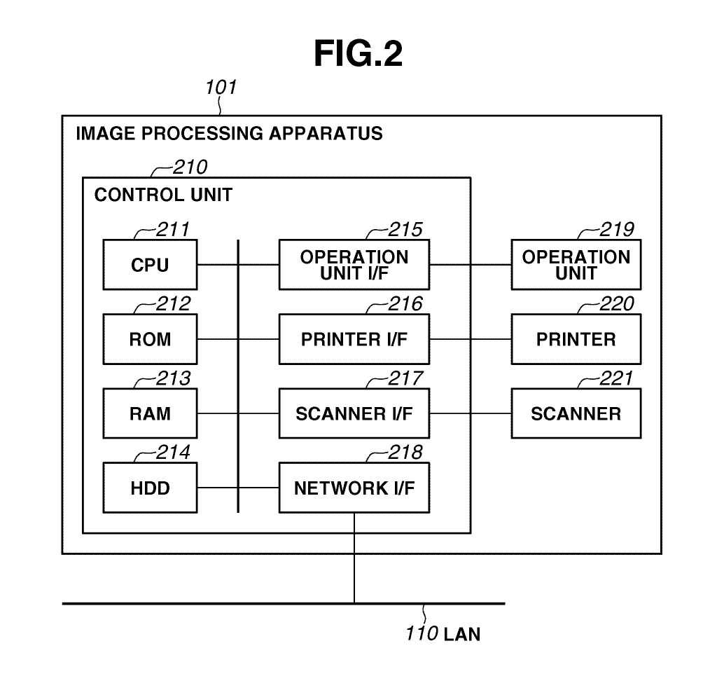

FIG. 2 is a block diagram illustrating a hardware configuration of the image processing apparatus 101. A control unit 210 including a central processing unit (CPU) 211 controls an operation of the entire image processing apparatus 101. The CPU 211 reads out a control program stored in a read-only memory (ROM) 212 and performs various types of controls such as reading control and transmission control. A random access memory (RAM) 213 is used as a temporary storage area of a main memory, a work area and the like of the CPU 211.

A hard disk drive (HDD) 214 stores image data, various types of programs, or various types of information tables. An operation unit interface (I/F) 215 connects an operation unit 219 to the control unit 210. The operation unit 219 is provided with a liquid crystal display portion having a touch panel function or a keyboard, or a user authentication portion that receives user authentication in a case where user authentication is performed using a card or the like.

A printer I/F 216 connects a printer 220 to the control unit 210. Image data that should be printed by the printer 220 is transferred from the control unit 210 via the printer I/F 216, and is printed on a recording medium in the printer 220.

A scanner I/F 217 connects a scanner 221 to the control unit 210. The scanner 221 reads out images on a document to generate image data, and inputs the generated image data to the control unit 210 via the scanner I/F 217.

A network I/F 218 connects the control unit 210 (the image processing apparatus 101) to the LAN 110. The network I/F 218 transmits image data or information to external apparatuses (for example, the cloud service server 131) on the LAN 110, and receives various types of information from the external apparatuses on the LAN 110.

### <Software Configuration Example—Image Processing Apparatus>

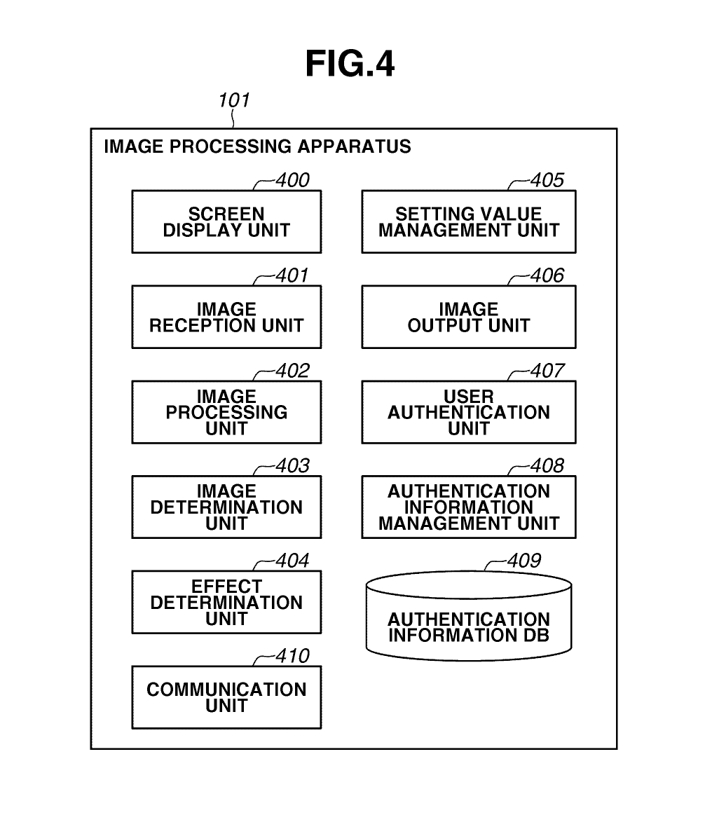

FIG. 4 is a diagram illustrating a software configuration of the image processing apparatus 101. Respective functional units illustrated in FIG. 4 are realized by executing the control program by the CPU 211 included in each of the image processing apparatus 101.

The image processing apparatus 101 includes a screen display unit 400, an image reception unit 401, an image processing unit 402, an image determination unit 403, an effect determination unit 404, a setting value management unit 405, an image output unit 406, a user authentication unit 407, an authentication information management unit 408, and an authentication information database 409. Further, the image processing apparatus 101 includes a communication unit 410. Hereinbelow, the authentication information database 409 is abbreviated as the authentication information DB 409.

Respective functions will now be described.

The screen display unit 400 performs display of a setting value to a user, and reception of the setting from the user. The image reception unit 401 receives input images. For example, when images input from the scanner 221 are copied, the image reception unit 401 receives the scanned images, and when the input images are printed from the terminal 102 such as a personal computer (PC), the image reception unit 401 receives page description language (PDL) or the like.

The image processing unit 402 performs various image processing on the received images. For example, in case of copying, modulation transfer function (MTF) correction, color conversion and image area determination are performed. In case of printing, processing for interpreting PDL and converting it into bitmap and color conversion processing are performed. Furthermore, the image processing unit 402 performs recommended processing such as blank-sheet skip, depending on a result of determination of the effect determination unit 404 described below. Then, in any of cases of copying and printing, the image processing unit 402 performs gamma correction or dither processing.

The image determination unit 403, if the recommended processing has been executed on the processing target image, determines whether an effect is achieved on an output result for each of the input images. In this case, when the user instructs an execution of the processing on the processing target image, it is assumed that the user has not set the recommended processing.

The effect determination unit 404, if the recommended processing has been executed on the processing target image, determines whether the recommended processing has an effect on the output result, from a setting value set by the user and a result determined by the image determination unit 403.

The setting value management unit 405 manages the setting value directly input by the user, and the setting value set by the authentication information DB 409 of the user described below. The setting value refers to an input condition or an output condition. For example, if an image is input using a scanner, the input condition refers to designation of resolution, designation of color reading(input)/monochrome reading(input), or two-sided reading in an automatic document feeder (ADF) of the scanner. Further, the output condition refers to designation of color output/monochrome output or the like, 2-in-1 setting or designation of two-sided output.

The image output unit 406 refers to a means for outputting images, and outputs print products.

The user authentication unit 407 performs user authentication. The user authentication is performed via, for example, an authentication by an authentication card or a form of inputting an ID and a password.

The authentication information management unit 408 manages authentication information that has been authenticated in the user authentication unit 407.

The authentication information DB 409 performs updating of the user authentication information according to an instruction of the authentication information management unit 408. Further, not only user information but also setting values which the user set in the past are stored in the database.

The communication unit 410 performs communication with the external PC terminal 102 or the cloud service server 131. The communication unit 410 performs transmission of images or notification of setting values.

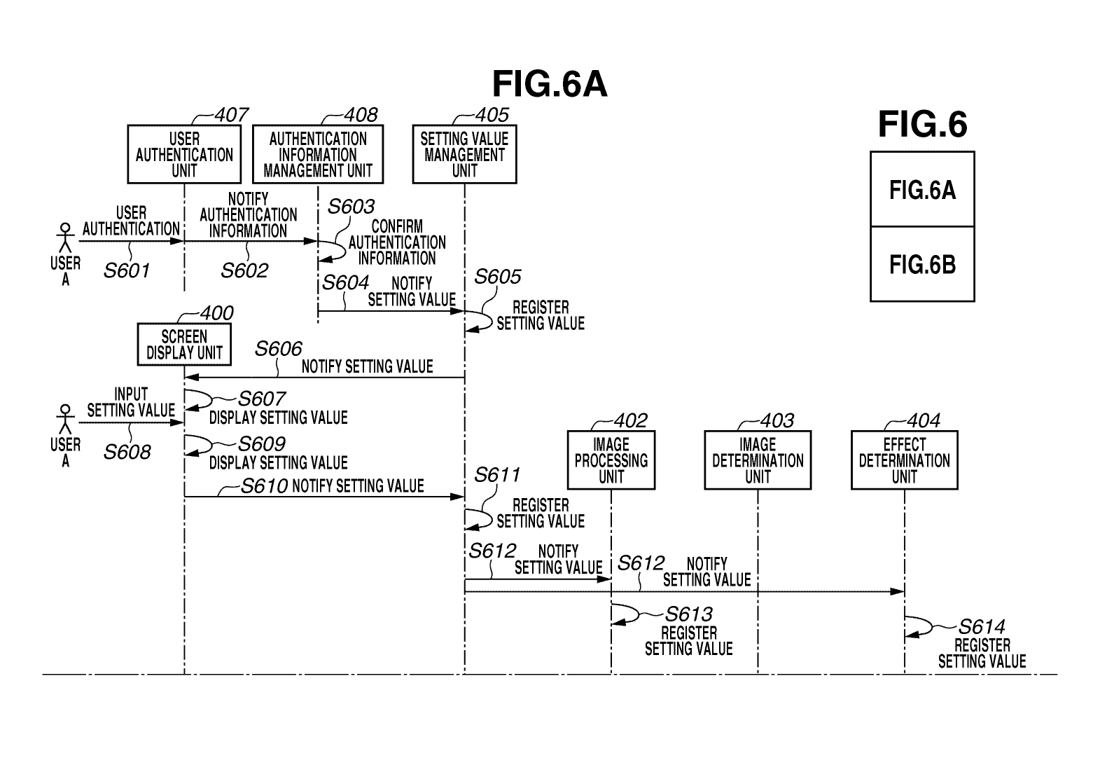

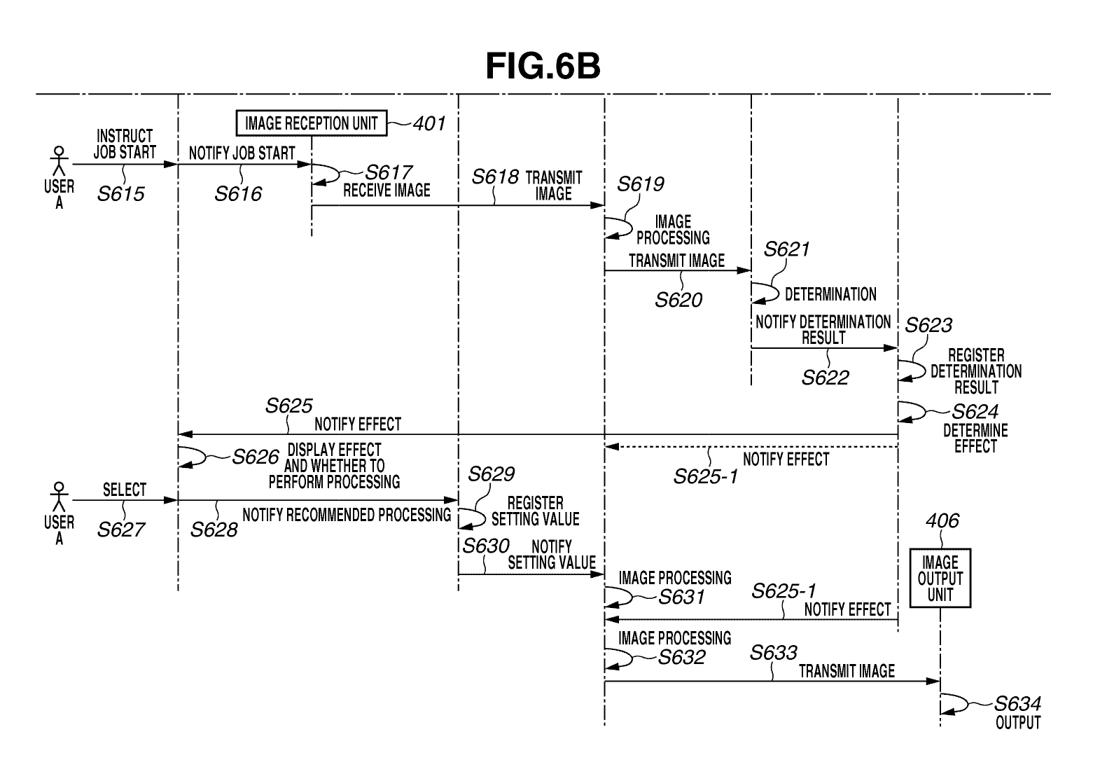

Hereinbelow, a sequence of the present exemplary embodiment will be described with reference to FIGS. 6A and 6B.

In this process, from an analysis result of the processing target image which is an input image, and a content of a setting value for the processing the target image, it is determined whether an effect is achieved, when the recommended processing is executed on the processing target image. Descriptions will be provided related to a sequence of recommending an execution of the recommended processing to the user to output the processing target image, if it is determined that an effect is achieved, and of not recommending an execution of the recommended processing to the user to output the processing target image, if it is determined that an effect is not achieved. Further, processing contents of the recommended processing, as will be additionally described below, include blank-sheet skip, character highlight, punched hole removal, book frame erasure and other processing. The descriptions of FIGS. 6A and 6B, however, will be provided by limiting the recommended processing to the blank-sheet skip.

In step S601, the user authentication unit 407 performs user authentication.

In step S602, the user authentication unit 407 notifies authentication information to the authentication information management unit 408.

When the authentication information is notified in step S602, then in step S603, the authentication information management unit 408 checks the authentication information against the authentication information DB 409. As a result of check-out, the authentication information management unit 408 determines whether use permission of the image processing apparatus 101 is given to the user. If the use permission is given, the authentication information management unit 408 acquires a setting value stored in the authentication information DB 409.

When the authentication information is notified in step S603, then in step S604, the authentication information management unit 408 notifies the setting value to the setting value management unit 405.

Upon receiving the notification in step S604, then in step S605, the setting value management unit 405 registers the setting value notified in step S604.

When the authentication value is registered in step S605, then in step S606, the setting value management unit 405 notifies the setting value registered in step S605 to the screen display unit 400.

Upon receiving the notification of the setting value in step S606, then in step S607, the screen display unit 400 displays the setting value notified in step S606.

In step S608, the screen display unit 400 receives a setting value newly set from the user via the screen displayed in step S607.

Upon receiving the setting value input in step S608, then in step S609, the screen display unit 400 displays the setting value newly set by the user in step S608 and the setting value stored in the authentication information DB 409.

Then, in step S610, the screen display unit 400 notifies the setting values displayed in step S609 to the setting value management unit 405.

In step S611, the setting value management unit 405 registers the setting values notified in step S610.

When the setting values are registered in step S611, then in step S612, the setting value management unit 405 notifies the setting value directly input by the user and the setting value set by the authentication information DB 409 of the user described below to the image processing unit 402 and the effect determination unit 404.

In step S613, the image processing unit 402 registers the setting values notified in step S612.

In step S614, the effect determination unit 404 registers the setting values notified in step S612.

In step S615, the screen display unit 400 receives start instruction from the user. The start instruction refers to starting of copying, or starting of a print job from the terminal 102 such as PC like secure print or anyplace print, using a button on the image processing apparatus 101. The secure print refers to storing in the image processing apparatus 101 the print job from the terminal 102 such as PC, and starting a print operation after the user has come to the image processing apparatus 101. This method is intended for preventing a print product from being seen or stolen by other users. The anyplace print refers to storing the print job from the terminal 102 such as PC in an external server such as the cloud service server 131 for allowing the user to execute printing from the image processing apparatus 101 which the user prefers. Since the present exemplary embodiment describes operations regarding a copying method, similar operations can be performed in the above-described printing method.

Upon receiving the start instruction in step S615, then in step S616, the screen display unit 400 notifies the start instruction received in step S615 to the image reception unit 401. In this process, receiving a plurality of sheets of input images by the ADF or the like is assumed.

In step S617, the image reception unit 401 receives processing target images. For example, a plurality of images is received by the ADF.

Upon receiving the images in step S617, then in step S618, the image reception unit 401 transmits the input images, which are the received processing target images, to the image processing unit 402.

In step S619, the image processing unit 402 executes image processing on the images transmitted in step S618 based on the setting values registered in step S613. As to the image processing unit 402, its processing will be described in detail. In this process, however, the image processing unit 402 executes image pre-processing of the image processing.

In step S620, the image processing unit 402 transmits the images processed in step S619 to the image determination unit 403.

In step S621, the image determination unit 403 executes the recommended processing, which is not instructed to be executed by the user, on the images transmitted in step S620.

In the present exemplary embodiment, the image determination unit 403 performs blank-sheet determination as the recommended processing, and determines whether the input images, which are the processing target images, are blank-sheets. The processing in the image determination unit 403 will be described below.

In step S622, the image determination unit 403 notifies a result of having performed the recommended processing on the processing target images to the effect determination unit 404. In this process, the image determination unit 403 notifies a result of whether each sheet of the input images, which are the processing target images, is a blank-sheet to the effect determination unit 404.

Then, in step S623, the effect determination unit 404 registers the result received in step S622.

In step S624, the effect determination unit 404 analyzes the content of the setting values notified in step S612 and the determination result notified in step S622, and determines whether an effect is achieved if the recommended processing is executed on the input images. In this process, it is determined whether an effect of paper saving is achieved, if the blank-sheet skip is performed depending on a result of the determination as to whether each input image is a blank-sheet with respect to all of the input images, and contents of the setting values registered in step S614. As to the effect determination unit 404, its processing will be described below in detail. The effect determination unit 404, if an execution of the recommended processing has an effect, advances the processing to step S625, and if it has no effect, advances the processing to step S625_1.

In step S625, the effect determination unit 404 notifies the screen display unit 400 that an execution of the recommended processing has an effect.

On the other hand, in step S625_1, the effect determination unit 404 notifies the image processing unit 402 that an execution of the recommended processing has no effect. In this case, the processing from step S626 to step S631 is not executed.

Now, a sequence when an effect is achieved will be described from step S626 to step S631.

In step S626, the screen display unit 400 displays that an effect is achieved on an output product when the recommended processing is executed, and displays a select button indicating whether to execute the recommended processing. The display method will be described below.

In step S627, the screen display unit 400 receives selection from the user via the screen displayed on the screen display unit 400 of step S626.

Upon receiving the selection in step S627, then in step S628, the screen display unit 400 notifies the setting value management unit 405 of a content of the recommended processing.

Upon receiving the notification in step S628, then in step S629, the setting value management unit 405 updates and registers the setting values in order to execute the image processing content including the recommended processing on the input images which are the processing target images. In this process, the authentication information DB 409 may be updated.

Then, in step S630, the setting value management unit 405 notifies the image processing unit 402 of the setting values registered in step S629.

When the setting values are notified in step S630, then in step S631, the image processing unit 402 executes the recommended processing. In the present exemplary embodiment, the image processing unit 402 executes the blank-sheet skip on the processing target images. The result acquired in step S621 may be used as the determination result.

Hereinabove, a case where it is determined as having an effect on executing the processing on the images according to the determination result in step S624 has been described. The following processing is performed in both cases of having an effect and having no effect.

In step S632, the image processing unit 402 performs image processing. In this process, gamma processing or dither processing is performed.

With respect to the image which has undergone the image processing in step S632, then in step S633, the image processing unit 402 transmits the image to the image output unit 406.

In step S634, the image transmitted from the image processing unit 402 in step S633 is output from the image output unit 406.

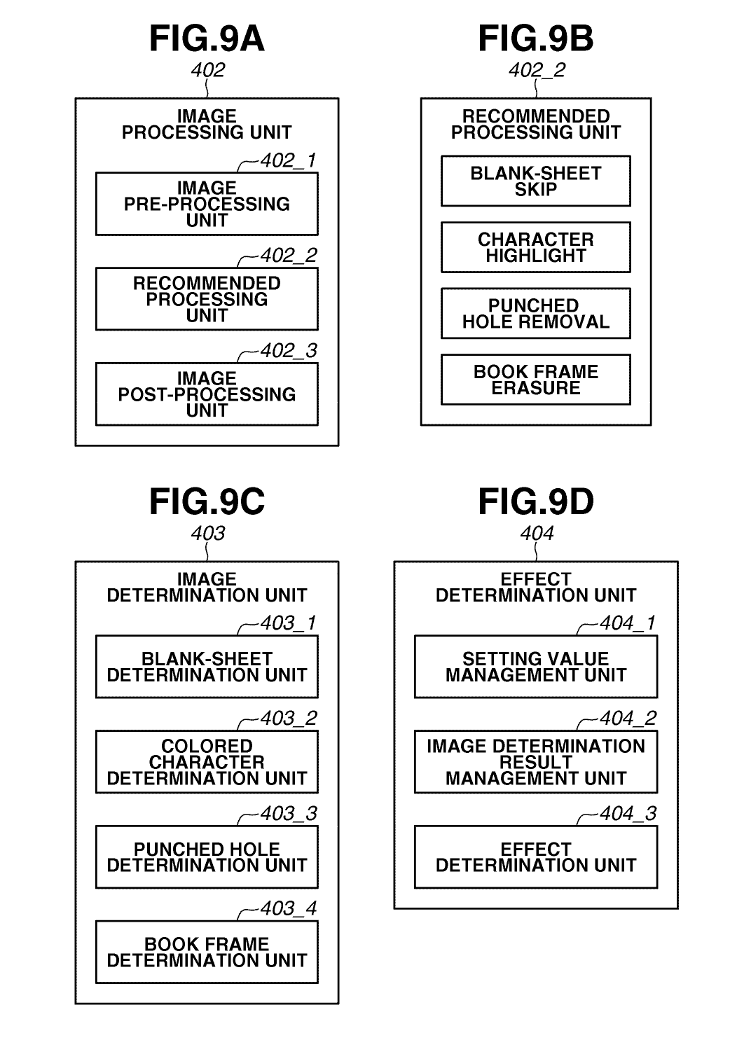

The image processing unit 402 will be described with reference to FIG. 9A.

The image processing unit 402 includes an image pre-processing unit 402_1, a recommended processing unit 402_2, and an image post-processing unit 402_3.

First, the image preprocessing unit 402_1 performs processing such as color conversion, MTF correction, or image area determination on images input from the scanner 221, and performs bitmapping of PDL data or color conversion on prints input from the terminal 102 such as PC.

Next, the recommended processing unit 402_2 executes processing which has an effect in a case where the processing is executed under the specific condition, though the user has not directly set. For example, the recommended processing includes blank-sheet skip processing, character highlight processing, punched hole removal processing, and book frame erasure processing, as illustrated in FIG. 9B.

Hereinbelow, a content of each processing will be briefly described. The blank-sheet skip processing includes, if an input image is a blank-sheet, not storing (not giving a printing instruction on) data obtained by reading the input image and putting the next page closer, to make up for the blank-sheet. Consequently, the blank-sheet skip processing has an effect of consumption reduction of unwanted paper output when the input images are printed.

Further, when original colored image is output in monochrome, characters originally written in color may become the ones with thin density. Therefore, the character highlight processing allows colored characters in colored image to be indicated in boldface or to be converted into shaded characters, when they are output to monochrome. Consequently, in a case where a portion which was output in color is output in monochrome, it has an effect of the ability to prevent characters from becoming the ones with thin density, and to create noticeable characters. The punched hole removal processing includes, if there are punched holes in the input image, filling in the area with surrounding color. As a result, the punched holes of the input image are filled, and the output product in which traces of the punched holes are not conspicuous can be obtained. Furthermore, since an area where the book is bound rises from the scanner 221 when the book is opened and copied, the book frame erasure processing has an effect of the ability to prevent the area from being copied in black when outputting. Then, a method for determining processing executed by the recommended processing unit 402_2 and having an effect is performed from the image determination unit 403, and the effect determination unit 404 as will be described below.

Then, in the image post-processing unit 402_3, processing such as color conversion, gamma correction, or dither processing is performed.

Hereinabove, the image pre-processing unit 402_1, the recommended processing unit 402_2, and the image post-processing unit 402_3 of the image processing unit 402 has been described.

The image processing unit 402 illustrated in FIG. 9A performs processing by the image pre-processing unit 402_1, in step S619 in the sequence illustrated in FIG. 6. Then, in step S621, the image processing unit 402 performs the blank-sheet skip processing by the recommended processing unit 402_2. Finally, in step S622, the image processing unit 402 performs processing by the image post-processing unit 402_3.

Now, the image determination unit 403 will be described with reference to FIG. 9C.

The image determination unit 403 includes a blank-sheet determination unit 403_1, a colored character determination unit 403_2, a punched hole determination unit 403_3, and a book frame determination unit 403_4.

The blank-sheet determination unit 403_1 determines whether an image obtained by reading a document is a blank-sheet, and notifies the effect determination unit 404 of the result. The colored character determination unit 403_2 determines whether there are colored characters in the read image, and notifies the effect determination unit 404 of the result. The punched hole determination unit 403_3 determines whether there are punched holes in the read image, and notifies the effect determination unit 404 of the result. The book frame determination unit 403_4 determines whether there is a black color image having an area equal to or greater than a threshold value in the center or near the edge of the input image, and notifies the effect determination unit 404 of the result. Since the recommended processing is intended to execute only the blank-sheet skip in FIG. 6, the image determination unit 403 illustrated in FIG. 9C performs blank-sheet determination by the blank-sheet determination unit 403_1 in step S621 of the sequence.

Then, the effect determination unit 404 will be described with reference to FIG. 9D.

The effect determination unit 404 includes a setting value management unit 404_1, an image determination result management unit 404_2, and an effect determination unit 404_3. The setting value management unit 404_1 receives setting values from the setting value management unit 405 and performs registration. The image determination result management unit 404_2 receives a determination result from the image determination unit 403 and performs registration. Then, the effect determination unit 404_3 refers to the setting value from the setting value management unit 404_1 and the determination result from the image determination result management unit 404_2 to determine whether the blank-sheet skip has an effect. If it has no effect, the effect determination unit 404_3 notifies the image processing unit 402 accordingly. On the other hand, if the blank-sheet skip has an effect, the effect determination unit 404_3 notifies the screen display unit 400 accordingly.

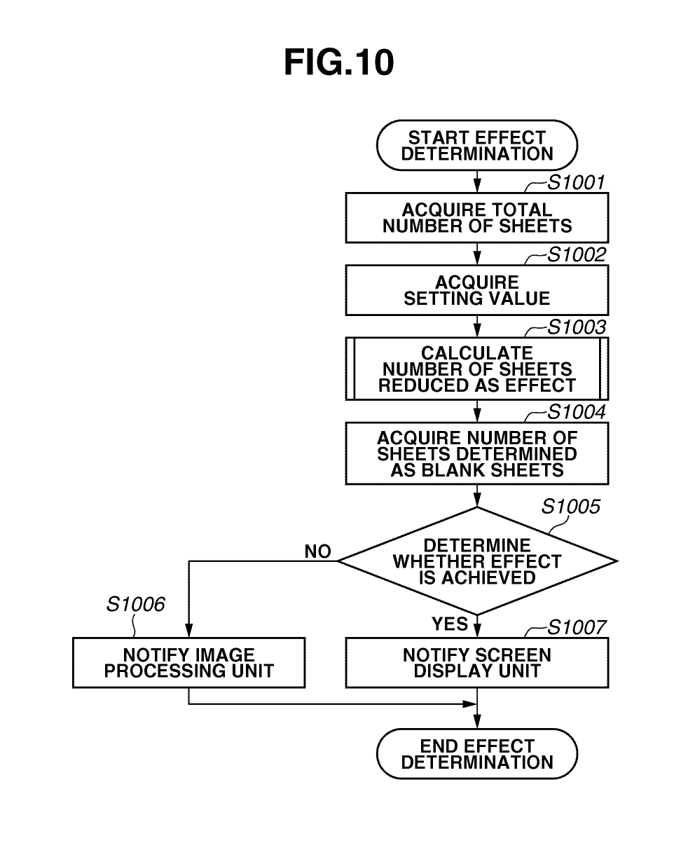

A flow regarding the effect determination unit 404_3 in the effect determination unit 404 in the effect determination of the blank-sheet skip will be described with reference to FIG. 10.

Respective steps in the flowchart are realized by loading a control program (not illustrated) stored in a storage device (not illustrated) in the image processing apparatus 101 into the RAM 213, and causing the CPU 211 to execute the control program.

First, in step S1001, the effect determination unit 404_3 acquires a total number of sheets indicating how many sheets the input images contain from the image determination unit 403. In this process, a total number of sheets may be acquired directly from the image reception unit 401.

Next, in step S1002, the effect determination unit 404_3 acquires setting values when inputting and outputting the input images which the setting value management unit 404_1 has registered in S614.

In step S1003, in a case where the effect determination unit 404_3 executes the blank-sheet skip using the values acquired in steps S1001 and S1002, the effect determination unit 404_3 determines how many sheets can be reduced as an effect when outputting. For example, the effect determination unit 404_3 acquires information indicating that a number of sheets of the input images is 120 sheets from step S1001, and acquires information indicating that a setting value of the output is A4/2-in-1/two-sided settings from step S1002. Then, four-sheet input images are assigned to one A4 sheet to be output. For this reason, when a number of sheets determined as blank-sheets is four sheets or more, A4 sheets to be output can be reduced. In this manner, a number of output sheets reduced as an effect of having executed the blank-sheet skip is determined.

Then, in step S1004, the effect determination unit 404_3 acquires a number of blank-sheets from the result determined as blank-sheets which has been registered by the image determination result management unit 404_2 in step S623.

In step S1005, it is determined whether an effect is achieved by comparing the number of sheets obtained in step S1003 and the number of sheets acquired in step S1004. Suppose that, for example, in step S1003, a number of sheets that can be reduced as an effect, when the blank-sheet skip is executed, is determined as 4 sheets or more, and a number of sheets determined as blank-sheets in step S1004 is 12 sheets. Then, it is determined that the blank-sheet skip has paper saving effect of 3 sheets (12/4=3).

In this process, if the blank-sheet skip has paper saving effect of one or more sheets, it is determined as having an effect. If it is determined that an effect is not achieved (NO in step S1005), the processing proceeds to step S1006. If it is determined that an effect is achieved (YES in step S1005), the processing proceeds to step S1007.

In step S1006, the effect determination unit 404_3 determines that an effect is not achieved, and notifies the image processing unit 402 accordingly. Therefore, the image processing unit 402 performs the image post-processing 402_3, without performing the recommended processing 402_2.

In step S1007, the effect determination unit 404_3 notifies the screen display unit 400. Then, the screen display unit 400 displays an effect of the recommended processing 402_2 to the user, and performs a display for facilitating selection whether to perform the recommended processing 402_2.

A display method for an effect of the recommended processing 402_2 performed by the screen display unit 400 or a display method for facilitating selection of whether to perform the recommended processing will be described.

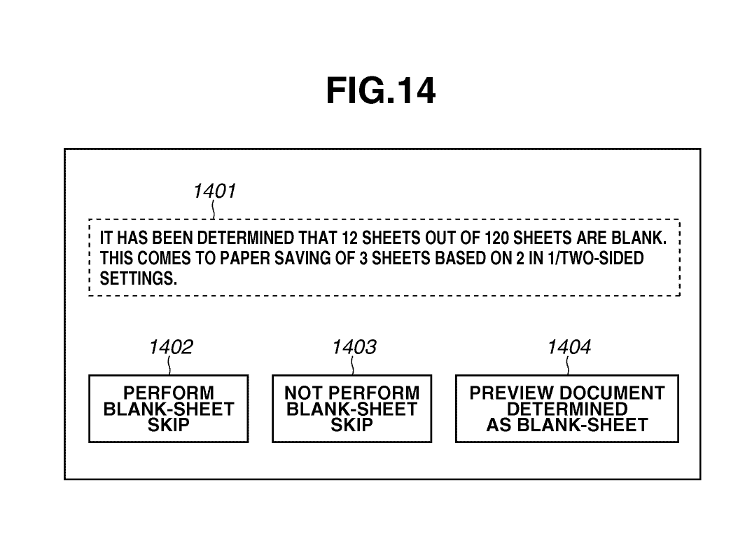

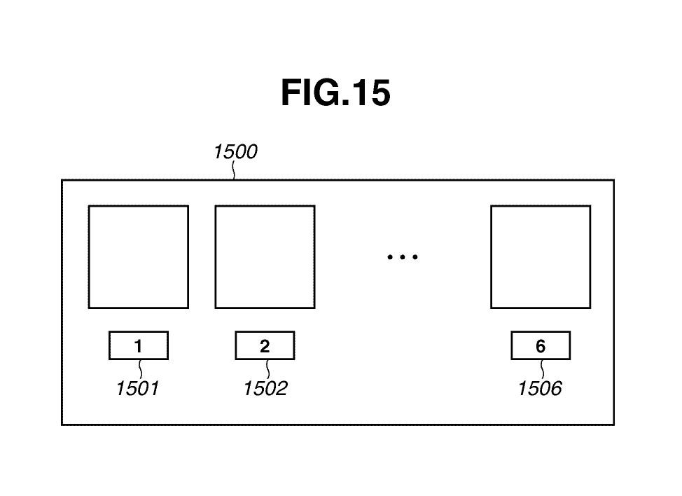

A display method for an effect of the recommended processing, in case of the blank-sheet skip, includes displaying a number of determined blank-sheets and a number of reduced sheets as illustrated in 1401 of FIG. 14, as an example. Further, buttons 1402 and 1403 for designating whether to perform the recommended processing are provided. The button 1402 is used to perform the blank-sheet skip, and the button 1403 is used not to perform the blank-sheet skip. Consequently, the user can select whether to perform the blank-sheet skip. Furthermore, by providing a button 1404 for previewing a document determined as blank-sheet, the user can confirm an effect achieved by blank-sheet skip execution. The blank-sheet determination may be overridden, and an effect may be re-acquired and displayed based on the result. For example, a UI display 1500 when the button 1404 has been pressed is illustrated in FIG. 15, and previews of images determined as blank-sheets can be performed as indicated in 1501, 1502, . . . 1506. Then, when the button 1501 is pressed, the blank-sheet skip for the image 1501 can be canceled.

From the above descriptions, in a case where image processing, which the user has not designated an execution on the processing target images, has been executed, it is determined whether an effect is achieved by the image processing based on an analysis result of the processing target images input by the user and a content of settings (input setting and output setting) for the processing target images.

Consequently, only when an effect is achieved, execution of the image processing can be suggested to the user. Therefore, even if the user does not find out, in detail, a condition and an intended use to which the function is applied, or an effect to be achieved when the function is actually applied, effective image processing can be executed on the processing target images.

In the present exemplary embodiment, the user can determine whether to actually perform the processing determined as having an effect. Once the user has determined to execute the processing, the user makes the authentication information DB 409 to be updated accordingly, and in the subsequent processing, the image processing determined as having an effect may be performed, even if not set by the user. As a result, convenience for the user can be improved.

Alternatively, the user may select whether to execute the processing for determining whether an effect is achieved due to the recommended processing, and for notifying the recommended processing.

Moreover, in the present exemplary embodiment, the blank-sheet skip has been executed as the recommended processing. In addition to this, with respect to a plurality of the recommended processing such as the character highlight, the punched hole removal, and the book frame erasure as well, determination of an effect may be performed and a display for recommendation may be performed with respect to the processing determined as having an effect.

In a first exemplary embodiment, in case of the blank-sheet skip, the user has to wait for determination results for all of the input images in order to determine an effect. Consequently, there is a possibility that printing speed may be slower than usual, depending on relationship between output speed of the printer 220 and reading speed of the scanner 221.

Thus, in a second exemplary embodiment, outputting is performed without performing the recommended processing on the input images, and the recommended processing will be presented after outputting. Consequently, a method for prompting the user to use the recommended processing at the next processing and later will be described.

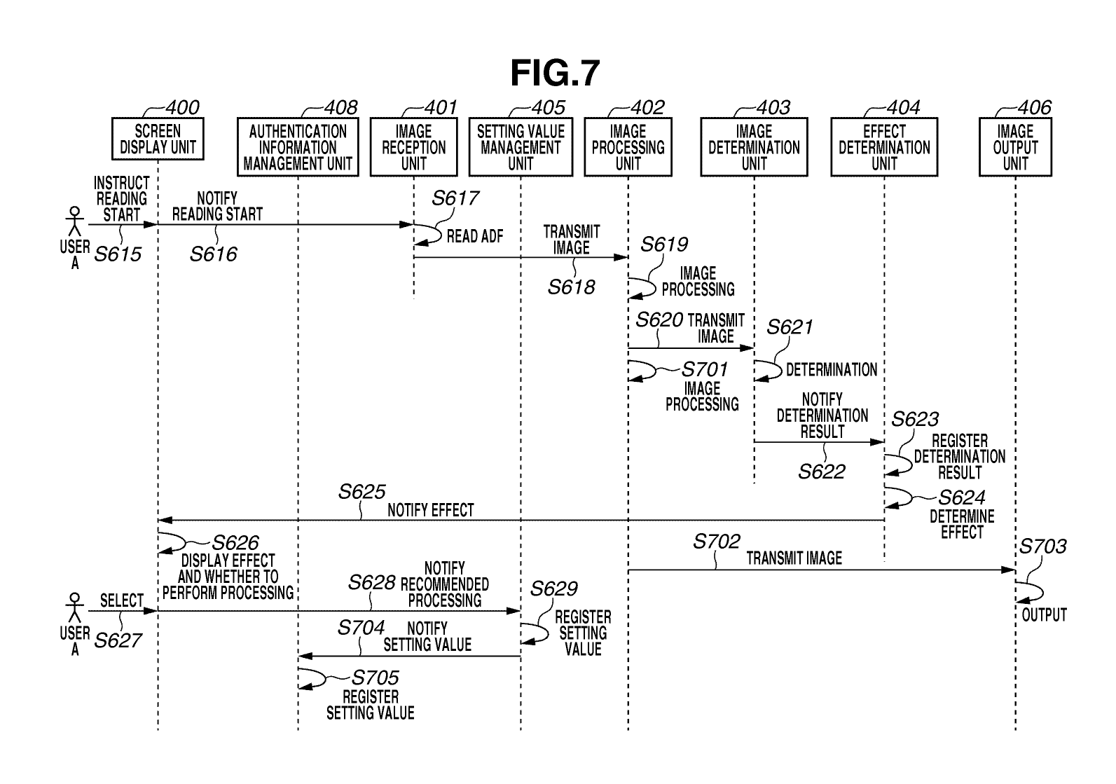

In the second exemplary embodiment, timings or processing in S621, S622, S623, S624 of FIG. 6 described in the first exemplary embodiment are different, and therefore, parts different from FIG. 6 will be described with reference to FIG. 7.

Hereinbelow, a sequence of the present exemplary embodiment will be described with reference to FIG. 7. The description regarding steps from S601 to S620 will not be repeated. First, in step S701, the image processing unit 402 performs the image post-processing 402_3, while the image determination unit 403 or the effect determination unit 404 is determining an effect in steps from S621 to S624.

Next, in step S702, the image processing unit 402 transmits an image after having been processed to the image output unit 406.

Then, in step S703, the image output unit 406 outputs the image.

On the other hand, if the effect determination unit 404 determines as having an effect in step S624, then in step S625, the effect determination unit 404 notifies the screen display unit 400 of the effect, and performs the same processing as the processing in the first exemplary embodiment in steps from S626 to S629. However, in step S624, if the effect determination unit 404 determines as having no effect, the effect determination unit 404 performs nothing and ends the processing. That is, the processing in steps from S626 to S629, and the following processing in steps S704 and S705 will not be performed.

In step S704, the setting value management unit 405 performs notification of the setting value to the authentication information management unit 408.

Then, in step S705, the authentication information management unit 408 registers the setting value.

Hereinabove, the exemplary embodiment in which the setting is displayed to the user as to whether to perform the recommended processing in the subsequent processing at the same time as the input image of the processing target is output has been described. Consequently, the user can know an effect of the recommended processing and a condition or a setting in which the recommended processing is effective, without dropping printing speed of the recommended processing. Even so, if determination by the effect determination unit 404 is too late in the outputting, for example, when the user has performed authentication to the image processing apparatus 101 at the subsequent processing, the previous result may be displayed to introduce the recommended processing.

From the above, even when it takes time to determine an effect of the recommended processing, it is possible to inform the user of the recommended processing without dropping printing speed. Further, by setting the recommended processing for authentication information, without the need for the user to care about a condition or a setting in which the recommended processing is effective in the subsequent processing, the recommended processing will become able to be automatically executed only when determined as having an effect.

Hereinabove, in the first and second exemplary embodiments, the blank-sheet skip out of the recommended processing has mainly been described. In the present exemplary embodiment, a case of recommending the character highlight will be described. In the present exemplary embodiment as well, similarly to the second exemplary embodiment, descriptions of the same configuration, processing and sequence as those in the first exemplary embodiment will not be repeated.

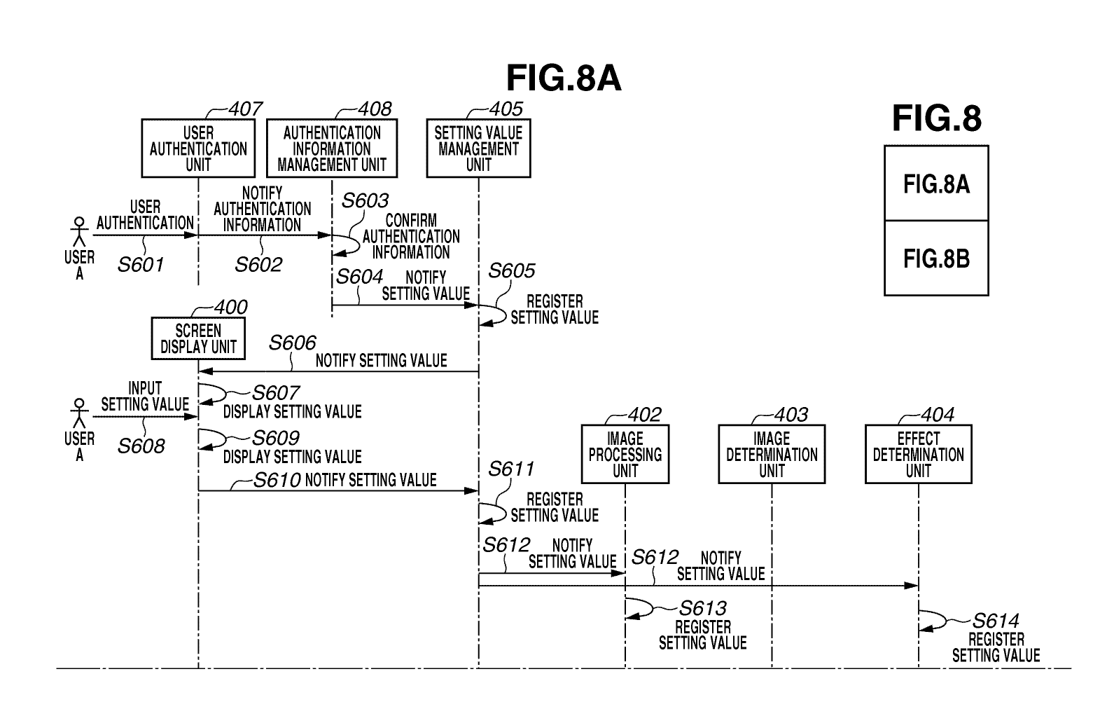

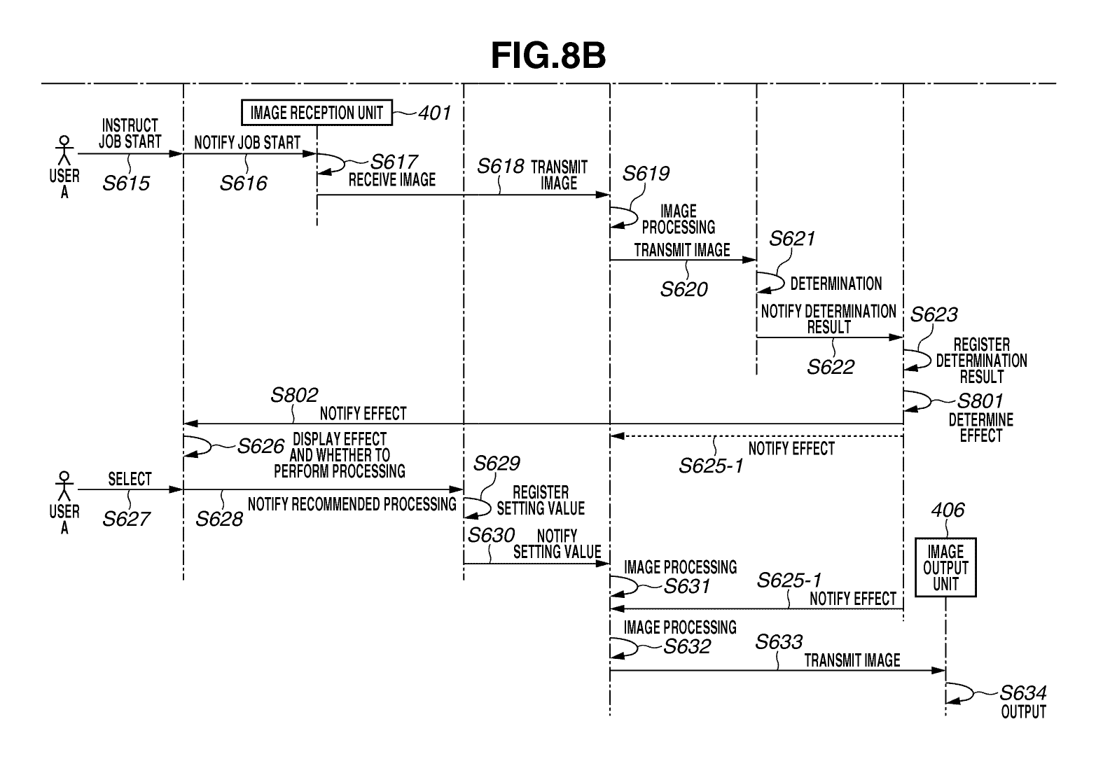

The character highlight refers to processing for determining colored characters and outputting in bold highlight, because colored characters become the ones with thin density when outputting in monochrome. For this reason, when outputting in color, an effect is not achieved. Therefore, contrary to the blank-sheet skip, in the character highlight, it can be determined in some cases that an effect is not achieved only from the setting value. Hereinbelow, a sequence in recommending the character highlight out of the recommended processing will be described with reference to FIGS. 8A and 8B.

The description regarding steps from S601 to S619 will not be repeated.

In step S801, the effect determination unit 404 determines whether an effect is achieved with respect to the setting value. If it is determined that an effect is achieved, then in step S802, the effect determination unit 404 notifies the image display unit 400 that an effect is achieved.

If it is determined that an effect is not achieved, then in step S625_1, the effect determination unit 404 notifies to the image processing unit 402 that an effect is not achieved. That is, the processing in steps from S627 to S631 is not performed but the processing in step S632 and after is performed to end the processing.

The processing in steps from S620 to S631 is the same as the processing in the first exemplary embodiment. However, in the image determination unit 403 in step S621, the colored character determination unit 403_2 determines whether there is a colored character in an image. And, the recommended processing performed by the image processing unit 402 in step S631 is the character highlight.

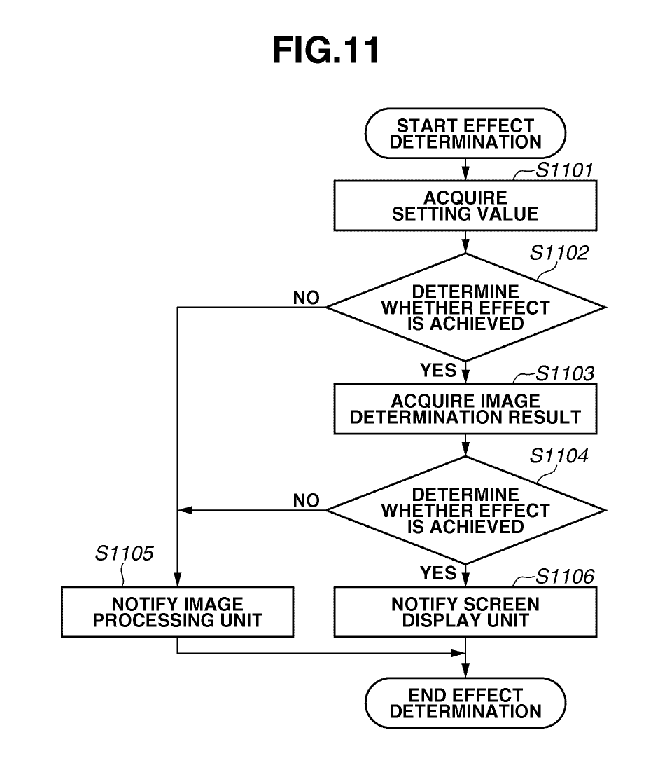

The flow regarding the effect determination unit 404_3 within the effect determination unit 404 of the character highlight, which is performed in step S801, will be described with reference to FIG. 11.

Respective steps of the flowchart are realized by loading a control program (not illustrated) stored in a storage device (not illustrated) of the image processing apparatus 101 into the RAM 213 and causing the CPU 211 to execute the control program.

First, in step S1101, the effect determination unit 404_3 acquires setting values of input and output registered by the setting value management unit 404_1 in step S614.

Next, in step S1102, the effect determination unit 404_3 determines whether an effect is achieved when the character highlight is executed on the processing target images based on the setting values of the input and output. The detailed flow in this process will be described below.

If it is determined, as a result of the determination, that an effect is achieved (YES in step S1102), the processing proceeds to step S1103, and if it is determined that an effect is not achieved (NO in step S1102), the processing proceeds to step S1105.

Then, in step S1103, the effect determination unit 404_3 acquires a determination result registered by the image determination result management unit 404_2 in step S623.

Thereafter, in step S1104, the effect determination unit 404_3 determines whether an effect is achieved when the character highlight is executed on the processing target images based on the result acquired in step S1103. If it is determined, as a result of the determination, that an effect is achieved (YES in step S1104), the processing proceeds to step S1106. If it is determined that an effect is not achieved (NO in step S1104), the processing proceeds to step S1105.

In step S1105, the effect determination unit 404_3 to the image processing unit 402 notifies that an effect is not achieved and ends the processing.

Accordingly, the effect determination unit 404_3 performs the image post-processing 402_3 without performing the character highlight.

In step S1106, the effect determination unit 404_3 notifies the screen display unit 400 that an effect is achieved. Then, the screen display unit 400 displays an effect of the character highlight, and performs display for prompting the user to make a selection whether to perform the character highlight on the processing target images.

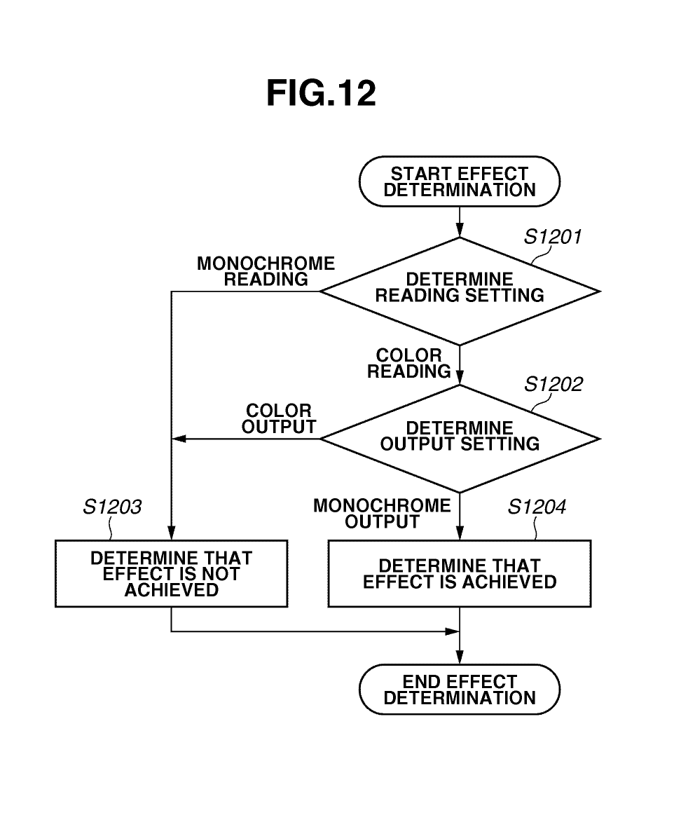

Now, the determination performed in step S1102 whether an effect is achieved will be described with reference to the flow of FIG. 12. In this case, a determination method when copying is performed will be described.

First, in step S1201, it is determined whether a reading setting of the scanner is set to color reading (color input). That is, if the scanner is set to monochrome reading (monochrome input), colored characters cannot be determined, and therefore it is determined that an effect is not achieved. Therefore, if color reading (color input) (COLOR READING in step S1201), the processing proceeds to step S1202. If monochrome reading (monochrome input) (MONOCHROME READING in step S1201), the processing proceeds to step S1203.

Next, in step S1202, it is determined whether an output setting is set to monochrome output. As described above, since the character highlight is the processing for highlighting colored characters in order to prevent the colored characters from becoming the ones with thin density when the colored characters undergo monochrome output, it is a rule to perform monochrome output. Therefore, if the output setting is set to monochrome output (MONOCHROME OUTPUT in step S1202), the processing proceeds to step S1204. If the output setting is set to color output (COLOR OUTPUT in step S1202) or color automatic determination, the processing proceeds to step S1203.

Then, in step S1203, the effect determination unit 404_3 determines that an effect is not been achieved and ends the effect determination. In step S1204, the effect determination unit 404_3 determines that an effect is achieved and ends the effect determination.

Finally, a display method for an effect of the character highlight or a display method for prompting the user to make a selection whether to perform the character highlight, which is to be performed in step S1106, will be described.

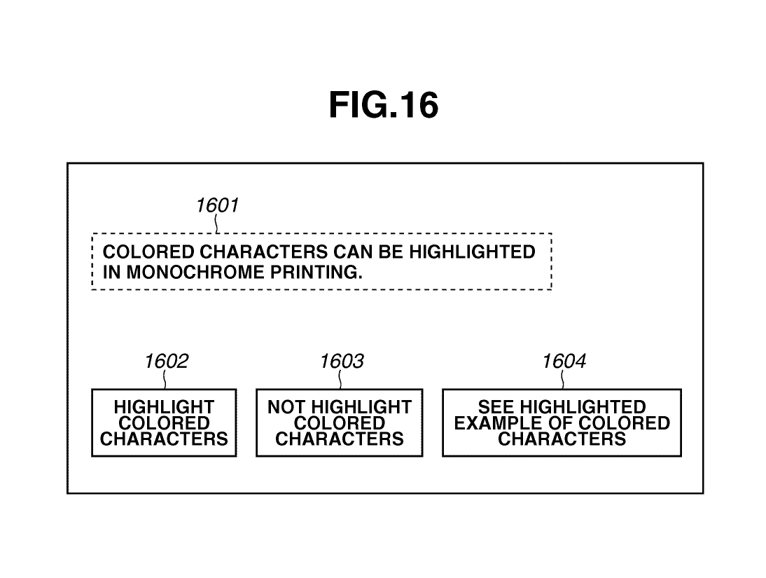

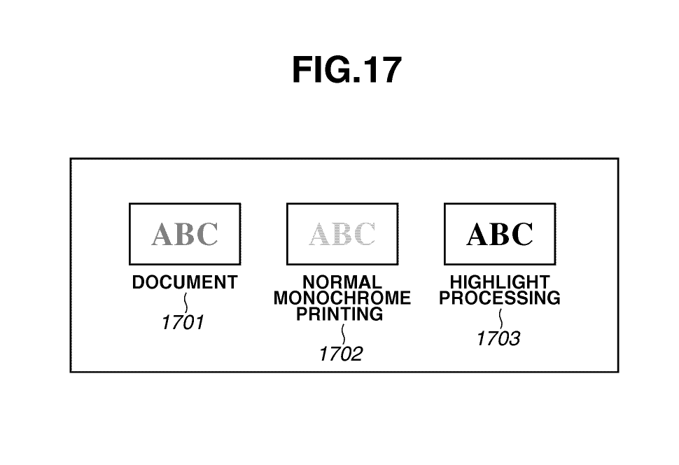

The display method for an effect of the character highlight includes displaying that an effect is achieved with respect to an output product, as illustrated in 1601 of FIG. 16, as an example. Further, there are provided buttons 1602 and 1603 for designating whether to perform the character highlight. The button 1602 is for issuing an instruction to perform the character highlight, and the button 1603 is for issuing an instruction not to perform the character highlight. Furthermore, there is provided a button 1604 for previewing an example of an image when colored characters are highlighted. The button 1604 provides an example of an image which allows the user to see improvement, such as monochrome output which has undergone the character highlight becoming 1703, as against monochrome output which should become 1702 with respect to colored character image 1701 of input as illustrated in FIG. 17.

Hereinabove, the exemplary embodiment by the character highlight other than the blank-sheet skip has been described.

Accordingly, by displaying an effect of the processing which the user has not consciously utilized, as with any processing other than the blank-sheet skip, an execution of the image processing can be suggested to the user only when an effect is achieved. Therefore, even if the user does not find out, in detail, a condition or an intended use to which the function is applied, or an effect which is achieved when the function is actually applied, an effective image processing can be executed on the processing target images.

Further, the user can determine whether to actually perform the processing which has been determined as having an effect. Once the user has determined to execute the processing, the user makes the authentication information DB 409 to be updated accordingly, and in the subsequent processing, the image processing determined as having an effect may be performed, even if not set by the user. As a result, convenience for the user can be improved.

In a fourth exemplary embodiment, a case of performing the recommended processing in the cloud service server 131 will be described.

### <Hardware Configuration Example—Cloud Service Server, Terminal>

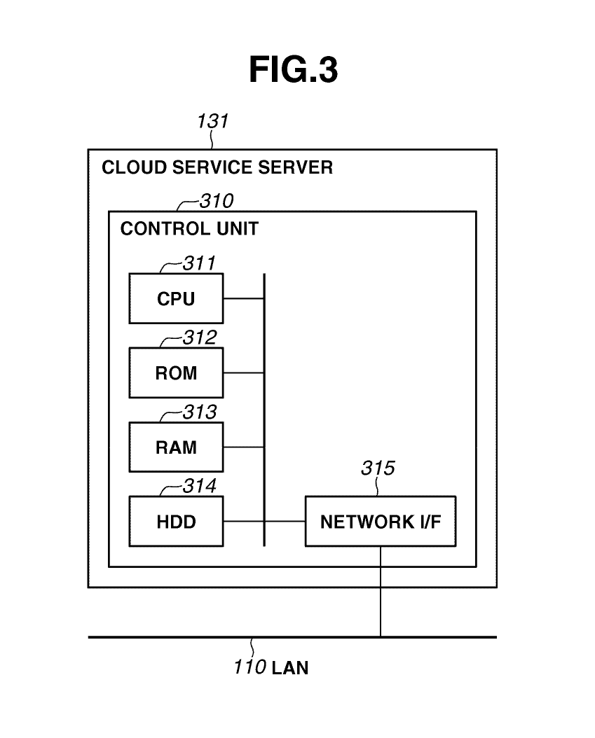

FIG. 3 is a block diagram illustrating a configuration of the cloud service server 131. A control unit 310 including a CPU 311 controls an operation of the entire cloud service server 131. The CPU 311 reads out a control program stored in a ROM 312 to execute various types of control processing. A RAM 313 is used as a temporary storage area such as a main memory or a work area of the CPU 311. An HDD 314 stores therein image data, various types of programs, or various types of information tables described below.

A network I/F 315 connects the control unit 310 (the cloud service server 131) to the Internet 120. The network I/F 315 transmits and receives various types of information between itself and other apparatuses on the LAN 110.

### <Software Configuration Example—Cloud Service Server>

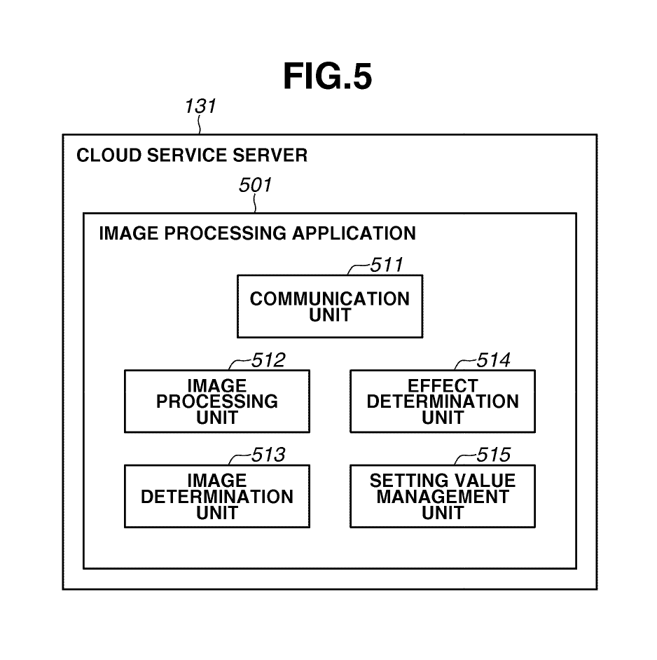

FIG. 5 is a diagram illustrating a software configuration of the cloud service server 131. Respective functional units illustrated in FIG. 5 are realized by executing the control program by the CPU 311 provided on each of the cloud service server 131.

The cloud service server 131 includes an image processing application 501.

The image processing application 501 includes a communication unit 511, an image processing unit 512, an image determination unit 513, an effect determination unit 514, and a setting value management unit 515.

Hereinbelow, the respective functions will be described.

The communication unit 511 receives an image or a setting value from the image processing apparatus 101 and the terminal 102 such as PC, transmits the image to the image processing unit 512, and notifies the setting value to the setting value management unit 515. The image processing unit 512 performs image processing based on the image transmitted from the communication unit 511 and the setting notified from the setting value management unit 515. The image determination unit 513 determines whether the recommended processing has an effect based on the image transmitted from the image processing unit 512. The effect determination unit 514 determines whether the recommended processing has an effect based on the setting value notified from the setting value management unit 515 and on the image determination unit 513. The setting value management unit 515 manages the setting value notified from the communication unit 511, and sends the setting value to the image processing unit 512 and the effect determination unit 514.

The image processing unit 512 within the cloud service server 131 is assumed to take the same configuration as that of the image processing unit 402 within the image processing apparatus 101. Similarly, the image determination unit 513 is assumed to take the same configuration as that of the image determination unit 403, the effect determination unit 514 as that of the effect determination unit 404, and the setting value management unit 515 as that of the setting value management unit 405.

<Sequence when Performing Image Processing on Cloud Service Server>

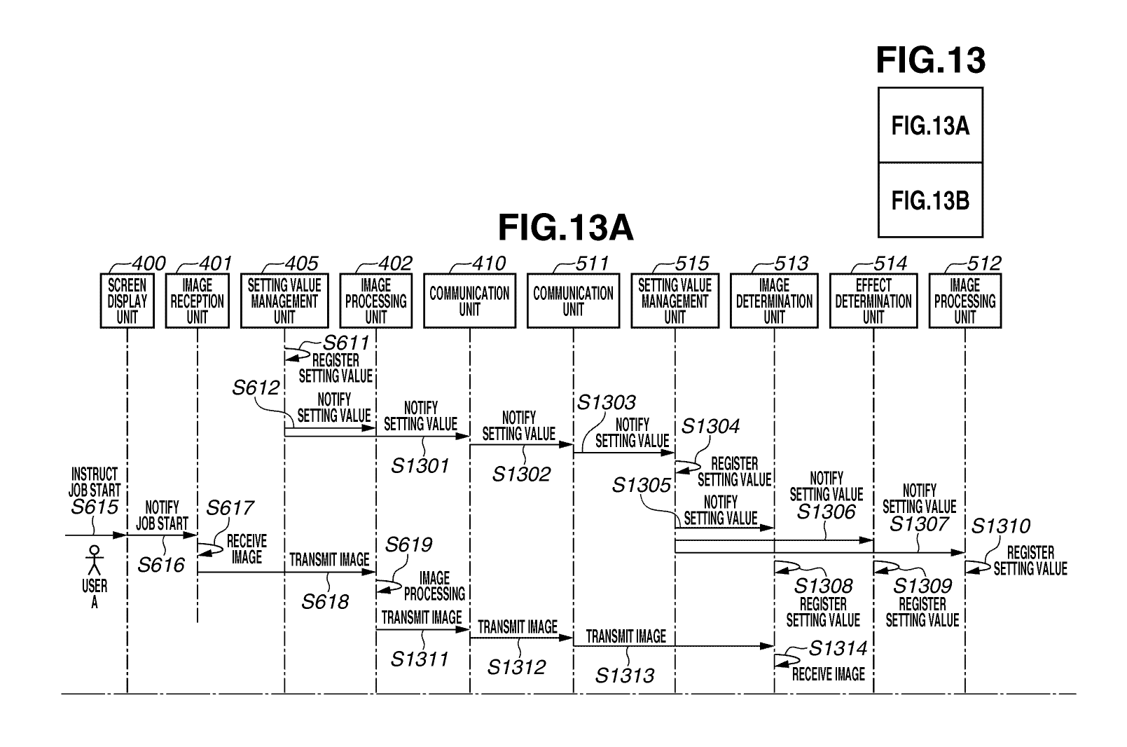

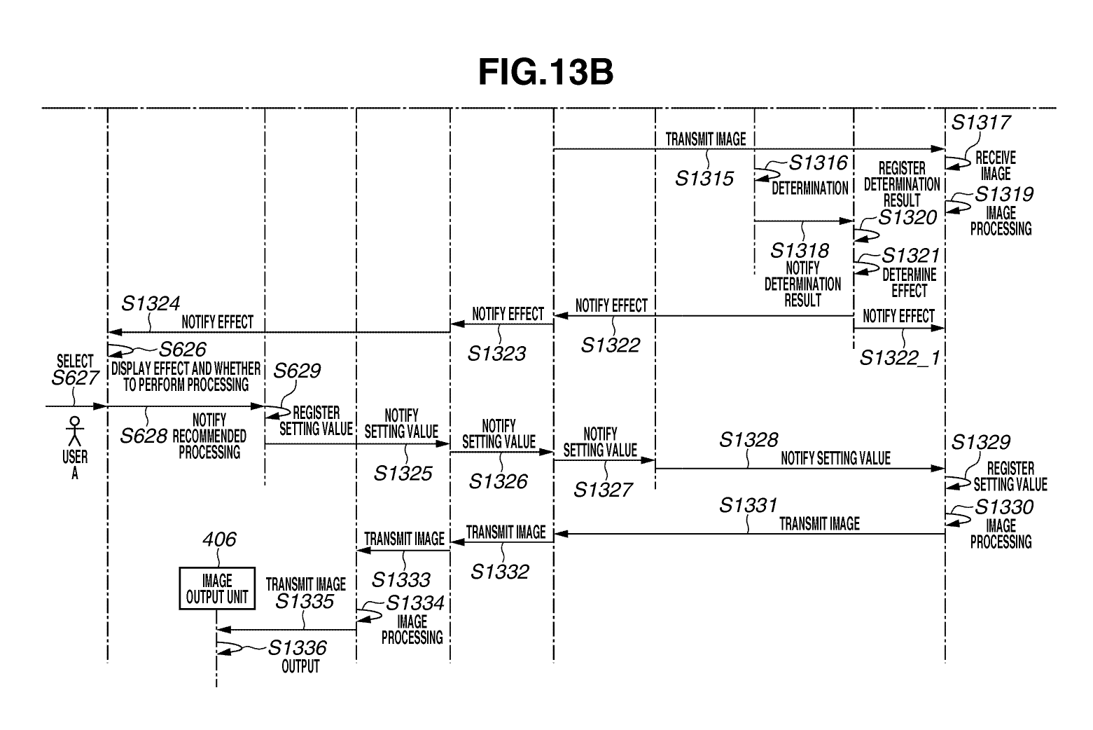

A case where the recommended processing is performed within the image processing unit 512 of the cloud service server 131 will be described. Descriptions will be provided with reference to FIGS. 13A and 13B, but descriptions of the same processing as those in FIG. 6 will not be repeated.

Illustrations and descriptions of steps from S601 to S610 will not be repeated in FIG. 13.

In step S611, the setting value management unit 405 performs registration of the setting values.

In step S612, the setting value management unit 405 notifies the image processing unit 402 of the setting values.

Then, in step S1301, the setting value management unit 405 notifies the communication unit 410 of the setting values.

Upon receiving the notification in step S1301, then in step S1302, the communication unit 410 within the image processing apparatus 101 notifies the communication unit 511 within the cloud service server of the setting values.

Then, in step S1303, the communication unit 511 notifies the setting value management unit 515 of the setting values.

In step S1304, the setting value management unit 515 registers the setting values notified in step S1303.

Then, in step S1305, the setting value management unit 515 notifies the image determination unit 513 of the setting values registered in step S1304.

Similarly, in step S1306, the setting value management unit 515 notifies the effect determination unit 514 of the setting values.

Similarly, in step S1307, the setting value management unit 515 notifies the image processing unit 512 of the setting values.

In step S1308, the image determination unit 513 registers the setting values.

In step S1309, the effect determination unit 514 registers the setting values.

In step S1310, the image processing unit 512 registers the setting values.

Descriptions of steps from S615 to S619 will not be repeated.

In step S1311, the image processing unit 402 transmits an image to the communication unit 410.

In step S1312, the communication unit 410 transmits the image transmitted in step S1311 to the communication unit 511.

In step S1313, the communication unit 511 transmits the image transmitted in step S1312 to the image determination unit 513.

Then, in step S1314, the image determination unit 513 receives the image.

In step S1315, the communication unit 511 transmits the image transmitted in step S1312 to the image processing unit 512.

Then, in step S1316, the image determination unit 513 determines the image. In this process, determination of the image is performed by the blank-sheet determination unit 403_1, the color character determination unit 403_2, the punched hole determination unit 403_3, and the book frame determination unit 403_4. In other words, when each processing is performed, determination whether an effect is achieved is performed.

In step S1317, the image processing unit 512 receives the image transmitted in step S1315.

In step S1318, the image determination unit 513 notifies the effect determination unit 514 of a determination result determined in step S1316.

In step S1319, the image processing unit 512 performs the image processing. In this process, the image pre-processing 402_1 is performed. Since the processing is also performed in step S619, only one of step S619 and step S1319 needs to be executed. Since the image processing unit 512 is provided on the cloud service server 131 and it is easy to add or update the image pre-processing 402_1, it is desirable, without performing the image processing 402_1 in step S619, to perform the processing in step S1319.

In step S1320, the effect determination unit 514 registers the determination result notified from the image determination unit 513 in step S1318.

In step S1321, the effect determination unit 514 determines whether the recommended processing has an effect based on the setting values registered in step S1309 and the determination result registered in step S1320.

If even one of the recommended processing has an effect, the processing in step S1322 and the subsequent steps are performed. If it is determined that any one of the processing has no effect, descriptions thereof will be separately provided.

In step S1322, the effect determination unit 514 notifies the communication unit 511 of the effect.

In step S1323, the communication unit 511 notifies the communication unit 410 of the effect.

Then, in step S1324, the communication unit 410 notifies the screen display unit 400 of the effect.

Hereinbelow, steps from S626 to S629 are the same as those in the first exemplary embodiment so that the descriptions thereof will not be repeated.

In step S1325, the setting value management unit 405 notifies the communication unit 410 of a content of the recommended processing.

In step S1326, the communication unit 410 notifies the content of the recommended processing to the communication unit 511.

Then, in step S1327, the communication unit 511 notifies the setting value management unit 515 of the content of the recommended processing.

Similarly, in step S1328, the setting value management unit 515 notifies the image processing unit 512 of the content of the recommended processing.

Then, in step S1329, the image processing unit 512 registers the setting values for executing the image processing content including the recommended processing.

Thereafter, in step S1330, the image processing unit 512 performs the image processing based on the setting values registered in step S1329. In this process, the image processing is performed based on any one of the recommended processing.

In step S1331, the image processing unit 512 transmits image to the communication unit 511.

In step S1332, the communication unit 511 transmits the image to the communication unit 410.

In step S1333, the communication unit 410 transmits the image to the image processing unit 402.

In step S1334, the image processing unit 402 performs the image processing. In this process, the image processing unit 402 performs the image post-processing 402_3.

In step S1335, the image processing unit 402 transmits the image to the image output unit 406.

In step S1336, the image output unit 406 outputs the image.

Hereinabove, in step S1321, a case where it is determined that the recommended processing has an effect has been described. If it is determined that the recommended processing has not an effect, in step S1322_1, the effect determination unit 514 notifies the image processing unit 512 that the recommended processing has not an effect. At that time, steps from S1322 to S1324, steps from S627 to S629, and steps from S1325 to S1330 are not performed, and steps from S1331 to S1336 are performed to end the image processing.

By the above processing, a case where the image processing is performed within the image processing unit 512 of the cloud service server 131 has been described.

The details will not be repeated in the present exemplary embodiment, but in a case where the recommended processing has been set as in the second exemplary embodiment, the authentication information DB 409 may be updated.

According to the above descriptions, even when determination by the effect determination unit 514 or image processing by the image processing unit 512 is performed within the cloud service server 131, the recommended processing can be recommended as in the first to third exemplary embodiments. Furthermore, as in the present exemplary embodiment, determination of an effect is performed and execution of the processing is recommended to the user only when an effect is achieved. Furthermore, by performing update of the setting on the authentication information DB 409, without awareness of a condition for performing the recommended processing, the recommended processing will be executed automatically only when it is determined that an effect is achieved. In the present exemplary embodiment, for simplification of descriptions, configurations of the image processing unit 402 within the image processing apparatus 101, and the image processing unit 512 within the cloud service server 131 are the same as each other. However, when the cloud service server 131 is used, there is a merit that it becomes easy to add new processing to image processing by the image processing unit 512 or determination by the effect determination unit 514.

Moreover, the authentication information DB 409 originally existing within the image processing apparatus 101 may be provided within the cloud service server 131, and user information and setting values may be stored therein. By doing so, the user can use the recommended processing existing in the cloud service server 131 without awareness of a condition for executing the recommended processing, not only in the image processing apparatus 101 for which the recommended processing has been set, but also in other image processing apparatuses 101.

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-257557 filed Nov. 26, 2012, which is hereby incorporated by reference herein in its entirety.

What is claimed is:

1. An image processing apparatus comprising:
a reception unit configured to receive a setting when an input image is output;
a determination unit configured, by acquiring a number of sheets of the input image and a content of the setting received by the reception unit and acquiring a number of output sheets reduced by executing blank-sheet skip processing on the image, to determine whether an effect is achieved when the blank-sheet skip is executed; and
a display unit configured to perform a display for prompting an execution of the blank-sheet skip processing determined as having the effect by the determination unit.

2. The image processing apparatus according to claim 1, wherein upon receiving an instruction to execute the blank-sheet skip processing displayed by the display unit, an image obtained by executing the blank-sheet skip processing displayed by the display unit on the image input by the input unit is output.

3. The image processing apparatus according to claim 1, wherein a display for prompting an execution of the blank-sheet skip processing is performed by the display unit before the image input by the input unit is output using the setting received by the reception unit.

4. The image processing apparatus according to claim 1, wherein when the image input by the input unit is output using the setting received by the reception unit, a display for prompting an execution of the blank-sheet skip processing is performed by the display unit.

5. The image processing apparatus according to claim 1, wherein when it is determined by the determination unit that the effect is achieved if the blank-sheet skip processing is executed, the display unit is caused to display an image determined as a blank-sheet of the input image and a number of reduced output sheets.

6. The image processing apparatus according to claim 5, further comprising an instruction unit configured to instruct whether to execute the blank-sheet skip processing on the image determined as a blank-sheet out of the input image displayed by the display unit.

7. The image processing apparatus according to claim 1, wherein an execution of the blank-sheet skip processing determined as having the effect, when executed, based on an analysis result of the image input by the input unit and a content of the setting received by the reception unit, is performed by a cloud service server.

8. A control method for an image processing apparatus, the method comprising:
receiving a setting when an input image is output;
by acquiring a number of sheets of the input image and a content of the setting received by the reception unit and acquiring a number of output sheets reduced by executing blank-sheet skip processing on the image, determining whether an effect is achieved when the blank-sheet skip is executed; and
performing a display for prompting an execution of the blank-sheet skip processing determined as having the effect by the determination unit.

9. The control method for the image processing apparatus according to claim 8, wherein upon receiving an instruction to execute the displayed blank-sheet skip processing, an image obtained by executing the displayed blank-sheet skip processing on the input image is output.

10. The control method for the image processing apparatus according to claim 8, wherein a display for prompting an execution of the blank-sheet skip processing is performed before the input image is output using the received setting.

11. The control method for the image processing apparatus according to claim 8, wherein when the input image is output using the received setting, a display for prompting an execution of the blank-sheet skip processing is performed.

12. The control method for the image processing apparatus according to claim 8, wherein when it is determined that the effect is achieved if the blank-sheet skip processing is executed, an image determined as a blank-sheet of the input image and a number of reduced output sheets are displayed.

13. The control method for the image processing apparatus according to claim 12, further comprising instructing whether to execute the blank-sheet skip processing on the image determined as a blank-sheet out of the displayed input image.

14. The control method for the image processing apparatus according to claim 8, wherein an execution of the blank-sheet skip processing determined as having the effect, when executed, based on an analysis result of the input image and a content of the received setting, is performed by a cloud service server.

15. A storage medium storing a program for causing a computer to execute,
receiving a setting when input image is output;
by acquiring a number of sheets of the input image and a content of the setting received by the reception unit and acquiring a number of output sheets reduced by executing blank-sheet skip processing on the image, determining whether an effect is achieved when the blank-sheet skip is executed; and
performing a display for prompting an execution of the blank-sheet skip processing determined as having the effect by the determination unit.
